(19) United States
(12) Patent Application Publication
(10) Pub. No.: US 2006/0181545 A1
(43) Pub. Date: Aug. 17, 2006

(54) Computer based system for selecting digital media frames

(75) Inventor: Tony Richard King, Cambridge (GB)

Correspondence Address: SYNNESTVEDT LECHNER & WOODBRIDGE LLP, P O BOX 592, PRINCETON, NJ, 08542-0592, US

(73) Assignee: Internet Pro Video Limited, Cambridge (GB)

(21) Appl. No.: 10/552,635

(22) PCT Filed: Mar. 31, 2004
(86) PCT No.: PCT/GB04/01354

§ 371 Date: Oct. 7, 2005

(30) Foreign Application Priority Data
Apr. 7, 2003 (GB) 0307884.7
Nov. 18, 2003 (GB) 0326796.0

(51) Int. Cl. G09G 5/00

(52) U.S. Cl. 345/619

(57) ABSTRACT

A computer based system for selecting digital media frames is capable of predicting the frames that are to be subject to a subsequent action. The subsequent action could be the selection of the predicted frames for inclusion to create a new set of frames consisting of the selected frames; it could also be the selection of the predicted frames for exclusion to create a new set of frames consisting of the frames but now excluding the selected frames. Because the system automatically predicts the frames that are, for example, to be included or excluded in a new clip, this removes the need for the user to manually define start and end frames. Instead, the user merely has to accept the predicted frames or refine the predicted selection. This is far quicker and requires less complex user interaction; these are very important advantages for a system designed for ordinary consumers, as opposed to professional audio or video editors. The system hence finds particular application in consumer oriented devices such as laptop computers, mobile PDAs with wireless connectivity, mobile telephones, set-top boxes; hard-disc based personal video recorders (PVR).

### TECHNICAL FIELD

This invention relates to a computer software system for selecting digital media frames. An end-user performs a subsequent action on the selected frames, such as editing (e.g. selecting some frames only for inclusion and discarding others) and trimming (e.g. discarding start or end frames).

### BACKGROUND ART

Application software for editing digital video is an extremely sophisticated and powerful tool because it is primarily designed for, and sold to, the video professional. Such an individual requires access to many complex functions and is prepared to invest time and effort in learning to become skilled in their use. Historically, the terminology and conventions of Digital Editing have evolved from a traditional film editing environment where rushes are cut and spliced together to tell a story or follow a script. As digital mixer technology advanced new techniques were combined with these conventional methods to form the early pioneering software based digital editors.

To the video or film professional editing is second nature and the complexities of a time-based media go unnoticed since, having already grasped concepts and learned processes, they are able to concentrate on the nuances of different editing packages, of which there are many.

Conventionally these packages, through the use of a Graphical User Interface (GUI), attempt to provide an abstraction of the media in terms of many separate tracks of video and audio. These are represented on the output device in symbolic fashion and provision is made for interacting with these representations using an input device such as a mouse. Typically the purpose is to create a new piece of media as an output file, composed by assembling clips or segments of video and audio along a timeline that represents the temporal ordering of frames. Special effects such as wipes and fades can be incorporated, transparent overlays can be added, colour and contrast can be adjusted. The list of manipulations made possible by such tools is very long indeed. A typical system is described in, for example, Foreman; Kevin J., et al, “Graphical user interface for a video editing system”, U.S. Pat. No. 6,469,711.

It is possible, however, that an individual who is a consumer of media, rather than a producer, may need to perform a simple editing operation on a media file in order to accomplish their primary task; for example to give a multi-media presentation. In this case such tools have their drawbacks. They may be too expensive to justify individually, or to have enough of in order to be available when or where needed. The limited amount of use and the small fraction of the capabilities used in such situations may make them uneconomic. The steep learning curve associated with such tools may mean that an inappropriate amount of effort is expended on something that is not the primary occupation or concern of the tool user. For occasional or infrequent use there will be reluctance on the part of any user repeatedly to switch environments or learn and relearn new tools to perform simple last minute tasks.

Work has been carried out with the view of improving the interaction between a user and a video editor by providing ‘intelligent’ operations. The ‘Silver’ project (Juan P. Casares. “SILVER: An Intelligent Video Editor.” ACM CHI'2001 Student Posters. Seattle, Wash. Mar. 31-Apr. 5, 2001. pp. 425-426) uses ‘smart selection’ to assist the user to find ‘in’ and ‘out’ points. The ‘in’ and ‘out’ points are roughly set by the user and then ‘snap’ to a boundary, which could be a shot change or the silence between spoken words, or other similar features. Video and audio boundaries typically will not line up so the system provides some ‘fixing-up’ functions to smooth the edit boundary.

Conventionally, video editors are application programs that run on high-end PCs and workstations, under desktop-oriented operating systems such as Microsoft Windows or Apple's Mac OSX, often with high-resolution screens and high-bandwidth network connectivity. The viewing of media files, however, can take place on an ever-expanding list of devices with many different capabilities, such as laptops, mobile PDAs with wireless connectivity, mobile phones, set-top boxes and hard-disc based personal video recorders (PVRs). The concept of a simple media manipulation tool integrated into the media player component is as relevant in these cases as it is in that of the standard PC, possibly more so since, for example, a PVR may not have a run-time environment capable of running external applications such as video editors.

Another class of device that is becoming ever more capable of media manipulation is the mobile phone. Such devices now have the ability to capture, display and transmit moving images, but, conventionally, are not thought of as a platform for editing video. There is no reason, however, why simple editing operations should not be applied here in order to enhance even the simplest and shortest of video presentations. Mobile phones present a unique set of challenges to the user interface component of any application. First and foremost the display area is extremely limited and so immediately rules out multi-level menus, timelines and story-boards. Secondly, the user interface is extremely constrained: there is no mouse input, only a few options can be displayed at a time, and all interaction must be performed using a set of navigation buttons (which may vary in position and size according to the hardware manufacturer). Thirdly, the user expects to be able to perform any action one-handed.

Accordingly, these are the attributes of a media frame selection tool that is appropriate to the needs of such a device.
Simple and intuitive to use; in particular, little time and effort is required to learn enough to accomplish the task in hand.
Efficient use of screen area; no menus, timelines or story-boards.
Efficient use of user input interface.
Efficient editing model that allows simple trimming operations to be performed simply, whilst permitting more complex tasks to be carried out.

### SUMMARY OF THE PRESENT INVENTION

In a first aspect, there is a computer based system for selecting digital media frames, the system being capable of predicting the frames that are to be subject to a subsequent selection action.

The subsequent selection action could be the selection of the predicted frames for inclusion in a new clip; it could also be the selection of the predicted frames for exclusion from a new clip. Once the clip (or an edit list) has been generated, it can be exported.

Because the system automatically predicts the frames that are, for example, to be included in or excluded from a new clip, this removes the need for the user to manually define start and end frames; instead, the user merely has to accept the predicted frames or refine the predicted selection. This is far quicker and requires less complex user interaction; these are very important advantages for a system designed for ordinary consumers, as opposed to professional audio or video editors. The system hence finds particular application in consumer oriented devices such as laptop computers, mobile PDAs with wireless connectivity, mobile telephones, set-top boxes; hard-disc based personal video recorders (PVR). The system can also be integrated with a media player application such that system controls are displayed at the same time as controls for the media player application are displayed. The frames can be video and/or audio frames.

The predictive functionality may work as follows: the device holds in device memory information that defines how a user has previously selected frames for inclusion or exclusion; the device uses that information to predict how the user wishes to select frames for inclusion or exclusion in the future in a way that is consistent with previous behaviour. More specifically, the information can determine the number of frames that the system predicts will be subject to selection. Also, the information held in device memory that is used for frame prediction can be updated whenever the user completes the subsequent selection action.

A graphical user interface may be included: this graphically represents frames and combines those graphically represented frames with a graphical indication of the prediction of which of those graphically represented frames are to be subject to the subsequent selection action.

Typical operation is as follows: the system predicts the frames that are to be subject to the subsequent selection action after the user has selected an initial frame. The initial frame is intended to be one of the following options: the sole frame to be used; the middle of a clip; the start of a clip; the end of a clip. The user can task or navigate through the options by repetitively selecting a button or menu option. Hence, if the user wishes the initial frame to be the middle of a clip, then the system predicts how may frames on either side of the initial frame should be included in the clip, based on previous user interactions. The user can then readily accept these frames for inclusion into the final clip. The user may also operate the system to predict what frames should be excluded in order to create a clip. For example, the user may set the initial frame to be the end of a clip; the system then predicts how many future frames should be excluded. Or the user may set the initial frame to be the start of a clip; the system then predicts how many earlier frames should be excluded. In any event, the prediction can be refined by the user manually extending, or reducing the extent of, the predictively selected frames.

### BRIEF DESCRIPTION OF DRAWINGS

The present invention will be described with reference to the accompanying Figures, which illustrate an implementation called VXT.

FIG. 1 shows the allocation of buttons to functions on a typical mobile device running VXT, together with the main graphical user interface elements.

FIG. 2 illustrates that graphical elements that label the buttons can be visible or invisible, according to the context.

FIGS. 3, 4, 5, 6 & 7 show the graphics that are superimposed on video frames to indicate whether they are to be included into, or excluded from, the final edit The colouring of the included and excluded regions on the edit bar is indicated on the arrows to the left of the device; these mirror the colouring of the superimposed ‘include’ tick and ‘exclude’ cross graphics. In FIG. 4 a single frame (the current one) only is included. In FIG. 5 a region centred on the current frame is included. In FIG. 6 all frames from the start of the clip up to the current frame are included. In FIG. 7 all frames from the current one through to the end of the clip are included.

FIG. 8 shows the major elements of the VXT system, which consist firstly of interactions of the user with the Graphical User Interface, secondly of system tasks carried out by a computer program, and thirdly of variables held in computer memory which have the property of persisting between invocations of the program.

FIG. 9 shows in more detail how the chosen region of video is refined.

FIG. 10 is an example of a C-language program that executes the system tasks.

FIGS. 11, 12, 13, 14, 15, 16 & 17 show the debug output from the program of FIG. 10 for various cases illustrative of how the system may be used. In FIG. 11 the predicted region is accepted. In FIG. 12 the region is grown by using the shuttle forwards or backwards button and then accepted. In FIG. 13 a single frame is chosen. In FIG. 14 two iterations of ‘move’ and ‘grow’ ate used to select a large region from the middle part of the video clip. In FIG. 15 a large region is selected by choosing to include all the frames from the start, or end, of the clip. In FIG. 16 the video is trimmed by excluding the start and end regions. In FIG. 17 a selected region is trimmed by excluding a smaller region from the front

### DETAILED DESCRIPTION

The invention is implemented in a system called VXT: VXT enables simple, predictive video message preparation, analogous to the predictive text editing for mobile ‘TXT’ing. VXT does not use the conventional editing semantics of ‘in’ and ‘out’ points; instead, it predictively determines edit limits using rules that are updated through user feedback It hence minimises the typical number of user interactions required to perform a simple video editing or trimming task.

Briefly, VXT works as follows.

The sequence of actions from the user loading a piece of digital media to the user applying the edits is called a ‘session’; the first operation the user performs during a session is called the ‘initial selection’; subsequent operations that the user performs are called the ‘refinement phase’; a frame or frames that are in the final edit are ‘included’; those that are not are ‘excluded’, an operation that causes a number of frames to change state from ‘excluded’ to ‘included’ or vice-versa is called a ‘grow’ operation; the actual number of frames that change state from ‘excluded’ to ‘included’, or vice-versa, during a grow operation is called the ‘support’.

Means are provided for storing, as variables in a computer memory, information about the history of interactions between the user and the video preparation tool; these are called ‘session vatiables’ and assist the user to determine the limits of initial selection, e.g. frames that are initially to be included or excluded by predictively identifying these frames.

In VXT, an integer session variable used for prediction called p is used automatically to predictively determine the number of frames labelled as ‘included’, as a proportion of the initial length of the clip, when the user makes the initial selection. When the program is used for the first time ever this session variable is set to an arbitrary initial value, for example, 4. If the length of the clip in frames is L then the support is given by s=L/p. For example, if s equals 4 and L equals 100 then the support s equals 25 frames. Therefore, if the user nominates a particular frame as being ‘included’, then the system determines that 25 frames previous, and 25 frames subsequent, to this frame, may also be included. Hence, an edited version of the clip can be rapidly generated.

After an editing session is complete, the actual number of frames (f) included in the final video message is read and is used to derive a new value of the session variable used for prediction p as follows: p(new)=2L/f. So, for example, if the length of the final message is 40 frames then the new value of p reflects the fact that fewer frames were actually required than were predicted, and the predicted p for the next edit session becomes 200/40=5. Assuming an initial length of 100 frames in the next editing session, a support value s equal to 20 frames is used for the next initial selection.

Means are also provided for using and updating the ‘session variables’ to assist the user to determine the limits of editing operations that occur during the refinement phase by predictively identifying frames to be included or excluded. These session variables hence reflect the history of prior user interactions—i.e. how the user has previously chosen to edit etc frames.

In the preferred embodiment, a vector of integer variables r(i) is used to model how the user refines the initial edit; the value of r(i) is equal to the difference in the value of the support variable s between the i−1, and ith refinement edit and is used to predict new values for s during refinement phases.

Any operation that results in a change of state of a frame from ‘excluded’ to ‘included’ is treated as a new edit and causes the index i in r(i) to increment.

A user interacts with a program running in computer memory in order to edit a video clip. The program is able to store and retrieve persistent variables to and from computer memory, that assists the editing operation.

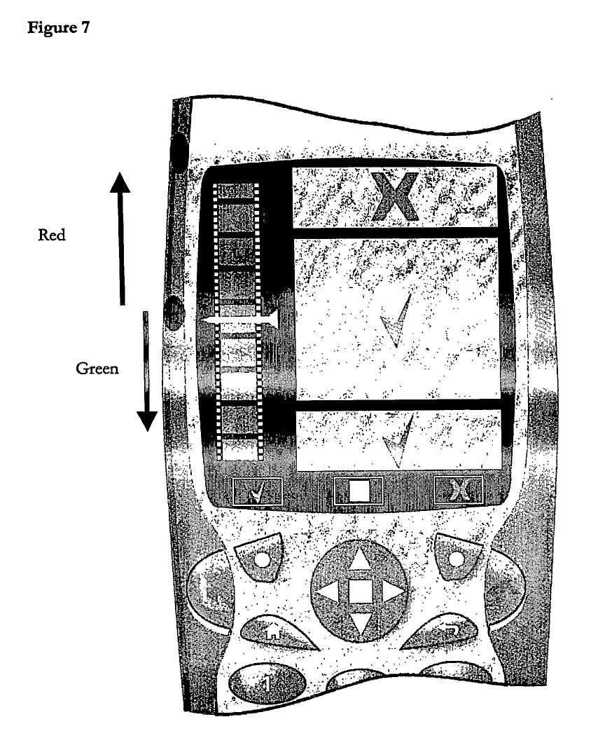

Referring to FIG. 8, in the preferred embodiment there are tasks carried out by the user, tasks carried out by the computer program, and variables in memory. The initial selection (800) involves the user choosing a current frame and the system using a stored value (811) to calculate an initial value for s which is used to create a tentative region of frames. The user may press the ‘apply’ button to take this region (805) and the region is exported as a new clip (804). Alternatively, the user continues to manipulate the user interface and the refinement phase (801) is entered. In this phase the user continues to make adjustments (806) that cause the refinement part of the computer program (802) to update the session variables (803) and to adjust the visual feedback to the user (807). This process iterates until the user is satisfied and chooses to export the result as a new clip (810). At this point the system updates the persistent variable p in memory (812).

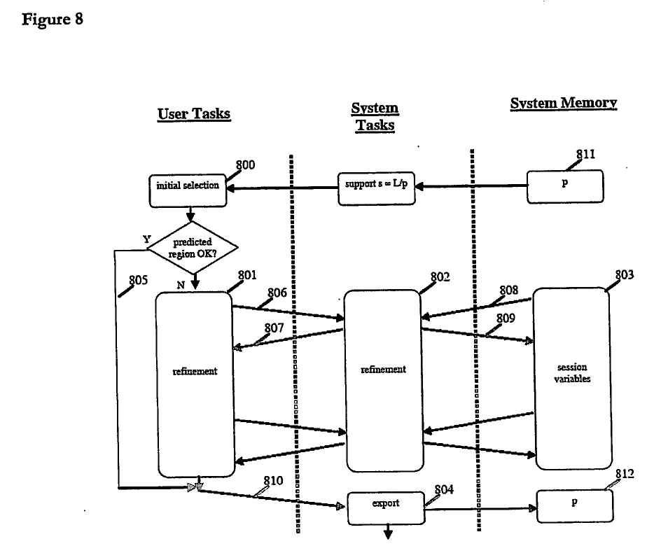

Referring to FIG. 9 the iterative refinement process operates as follows. The user operates the include and exclude buttons repeatedly (901), as described below, in order to select a region of frames for inclusion. Stored variables (902) are used to determine the sizes of blocks of frames added or subtracted during this process. This cycle is ended when the user moves to a new current frame at which point the system (905) updates the stored variables pertinent to this iteration. The user decides (907) whether or not to take this region; if so the refinement phase ends (908), otherwise it continues in the same mode of operation until the feedback from the system (909) is such that the user is satisfied with the result (910) and the process terminates.

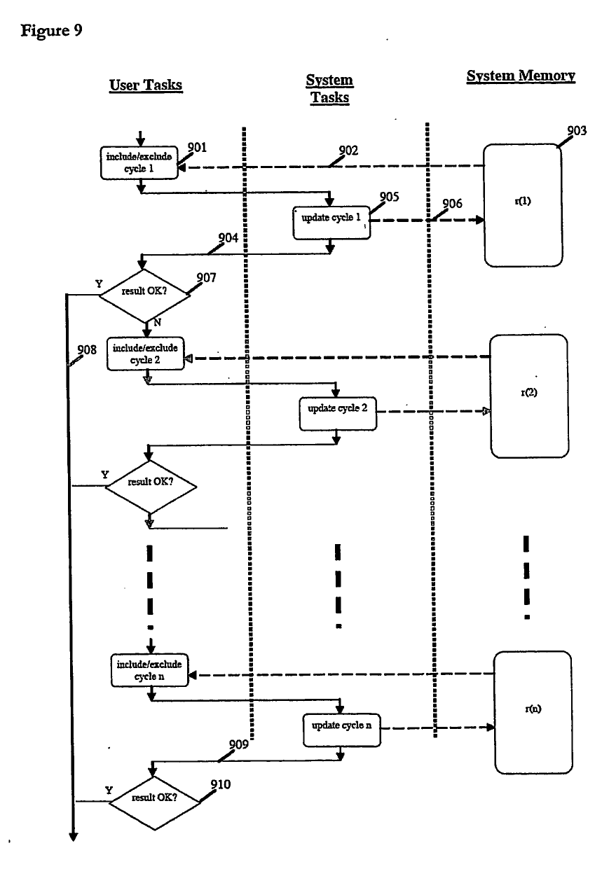

FIG. 10 is a example of a program written in the C language for carrying out the described functions. The program essentially consists of a loop that inputs the user interactions and updates variables that represent the edit points accordingly.

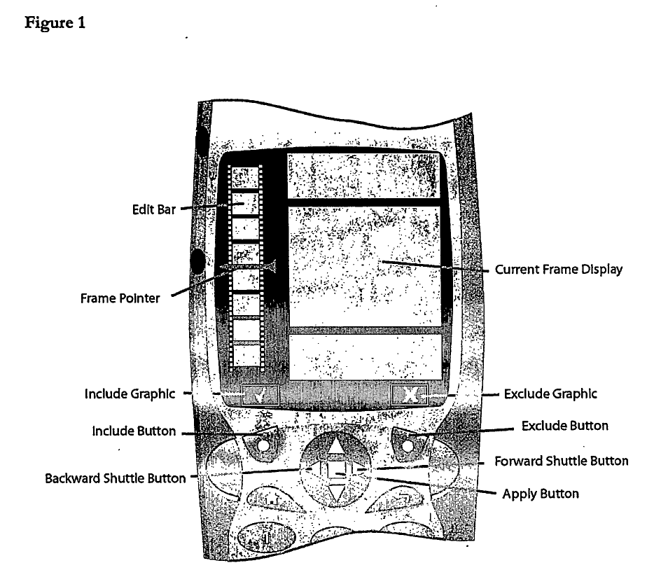

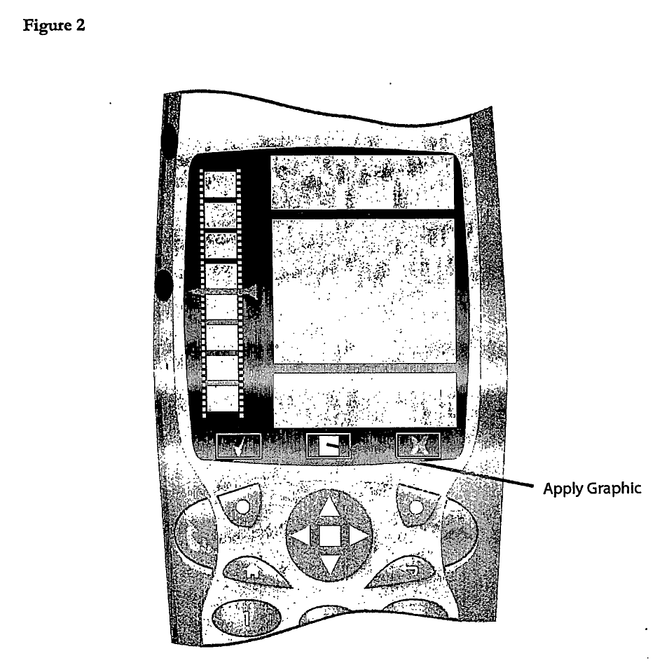

A Graphical User Interface (GUI) input interface for editing is defined; referring to FIGS. 1 and 2; in the preferred embodiment the controls consist of five buttons:
one for video ‘forward’ shuttle;
one for video ‘backward’ shuttle;
one button meaning ‘include’;
one button meaning ‘exclude’;
one button meaning ‘apply’.

A Graphical User Interface (GUI) output interface for editing is defined for feedback to the user.

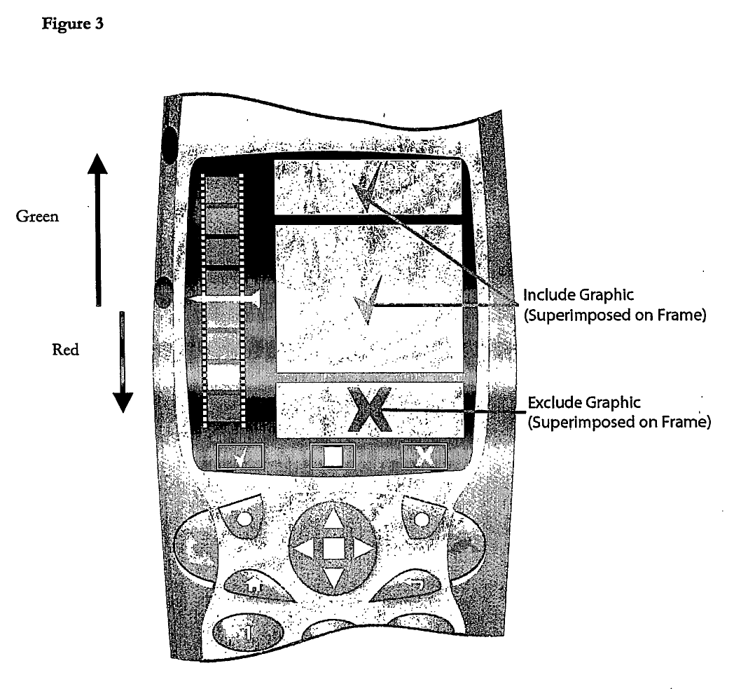

Referring to FIG. 3; in the preferred embodiment the graphical elements consist of:
an ‘edit bar’ graphic on the display; this comprises a sequence of coloured rectangular areas.
a ‘frame pointer’ that marks the current frame on the edit bar.
A ‘frame display’ that shows the current frame and optionally portions of adjacent frames.
an ‘include’ graphic which overlays the corresponding frame shown in the frame display and consists of a green ‘tick’;
an ‘exclude’ graphic which overlays the corresponding frame shown in the frame display and consists of a red ‘cross’.

Means are provided for the user to select the region of the video message that is of interest.

In the preferred embodiment, the user operates the ‘forward’ and ‘backward’ shuttle buttons to find a representative frame in the part of the clip that is ‘of most interest’. The desired frame is displayed in the frame display along with smaller, under-sampled versions of the previous and following frames.

Means are provided to feedback to the user, without the user having to preview the edit, frames that are ‘included’ and ‘excluded’. In the preferred embodiment the ‘edit bar’ represents the video clip being edited and a pointer in the ‘edit bar’ indicates the frame currently being viewed. The edit bar is in effect a zoomed out view of the frame display with no media content in each rectangular area. It gives context to the editing operations. Regions of the bar that are green represent ‘included’ sections; regions that are red represent ‘excluded’ sections. The colour is indicated next to the vertical arrows to the left of the mobile phone. Prior to any editing taking place the bar is completely red, meaning that all the frames are ‘excluded’.

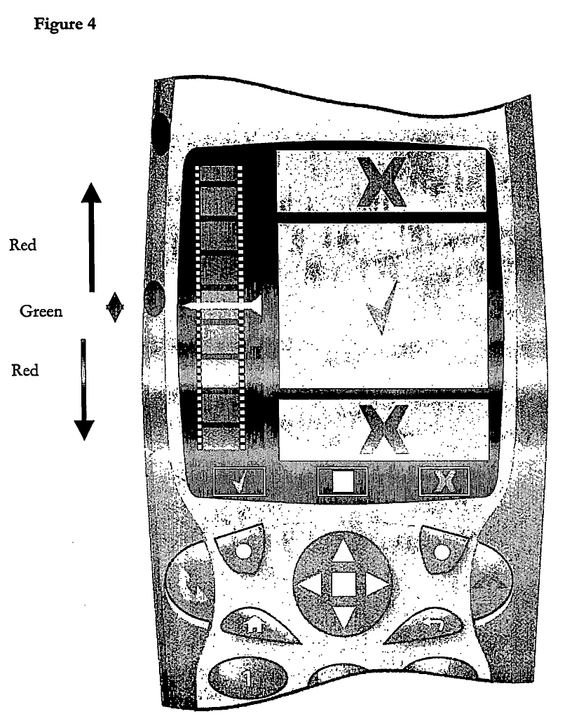

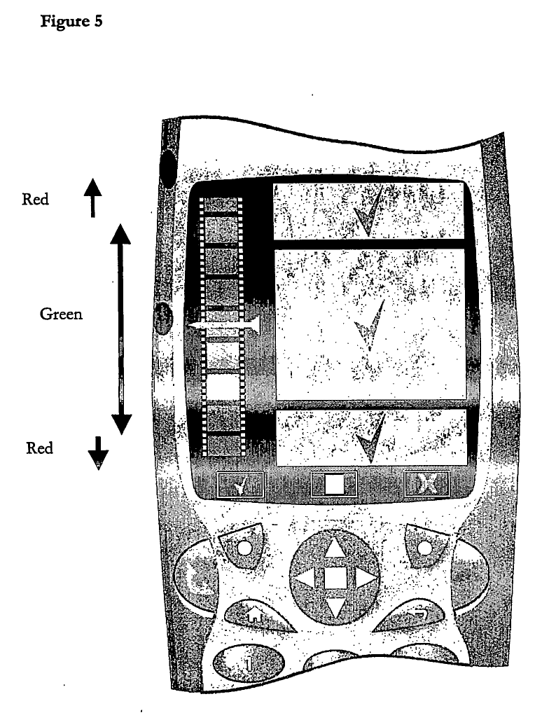

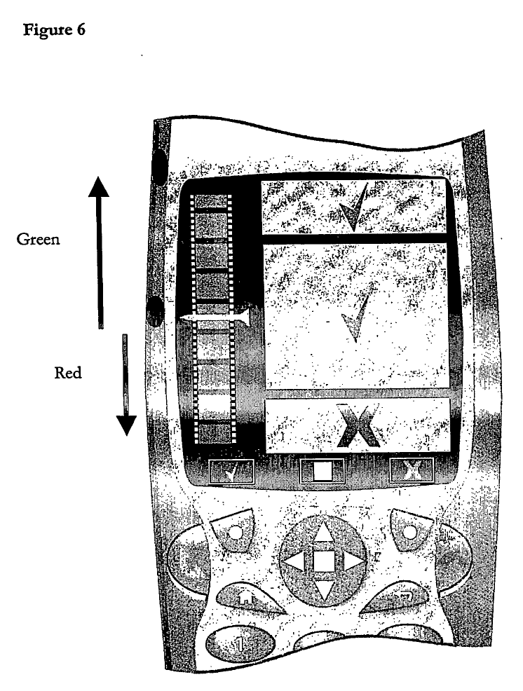

Means are also provided to feedback to the user, involving the user previewing the edit, and frames that are ‘included’ and ‘excluded’. Referring to FIGS. 4, 5, 6 & 7; in the preferred embodiment each frame shown in the frame display that is ‘included’ is overlaid with a green ‘tick’ and each frame that is ‘excluded’ is overlaid with a red cross. The user can review these frames using the forward and backward shuttle controls.

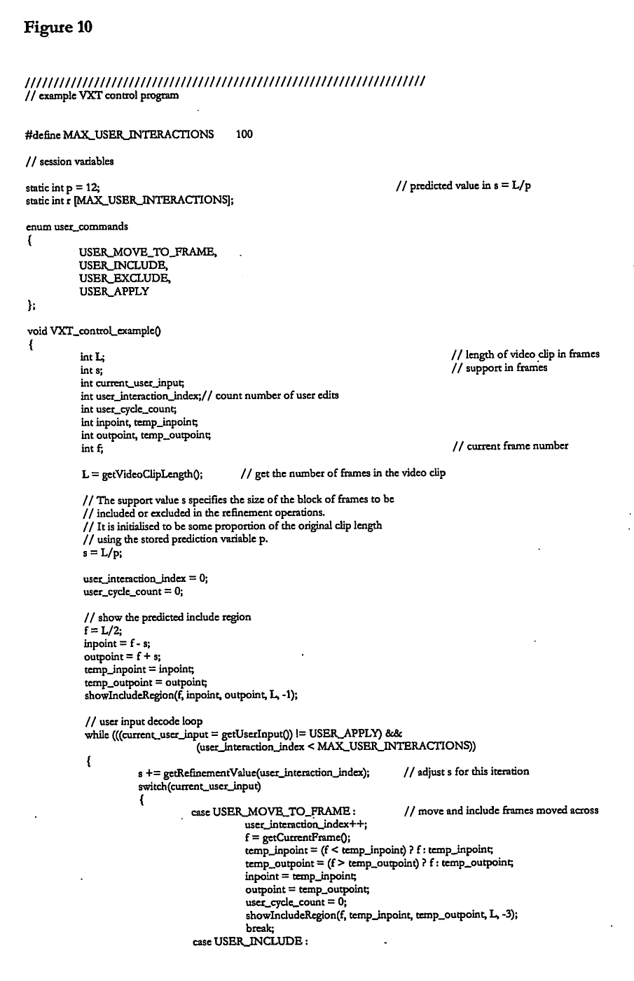

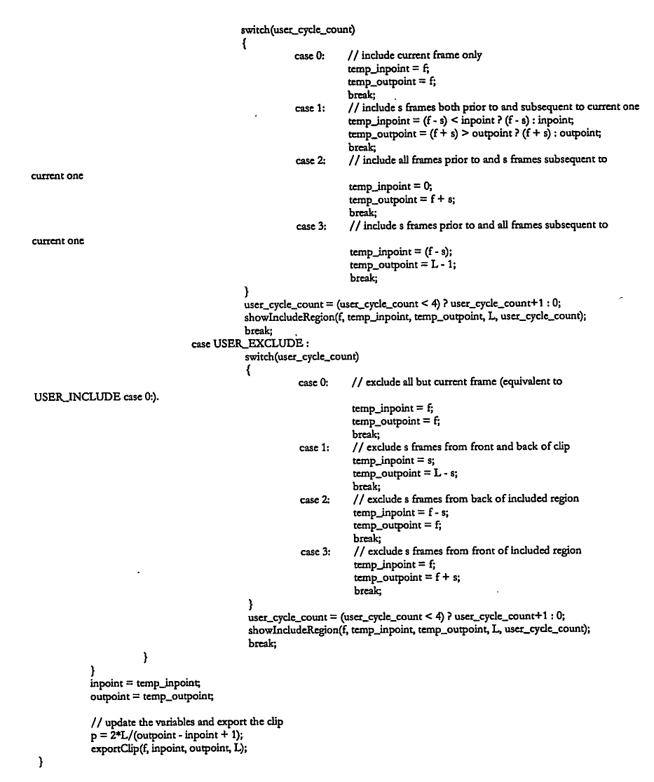

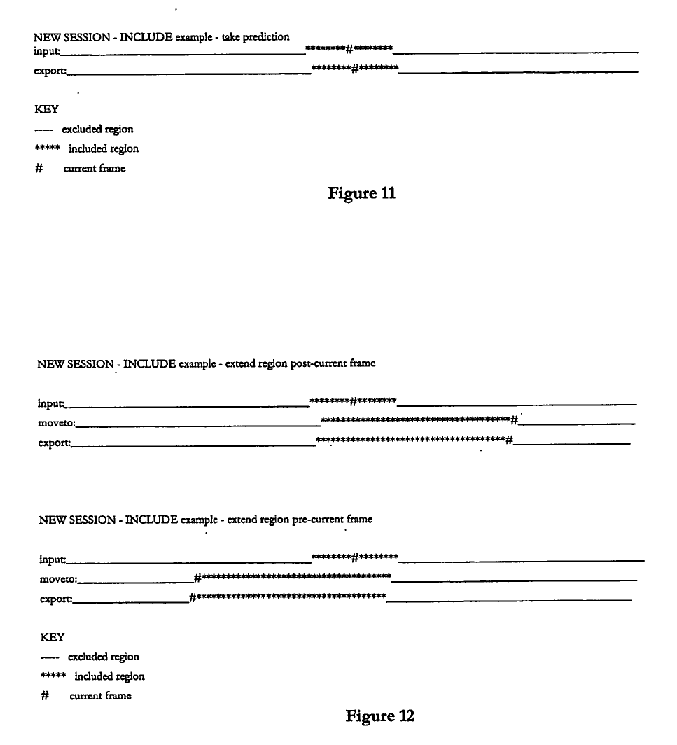

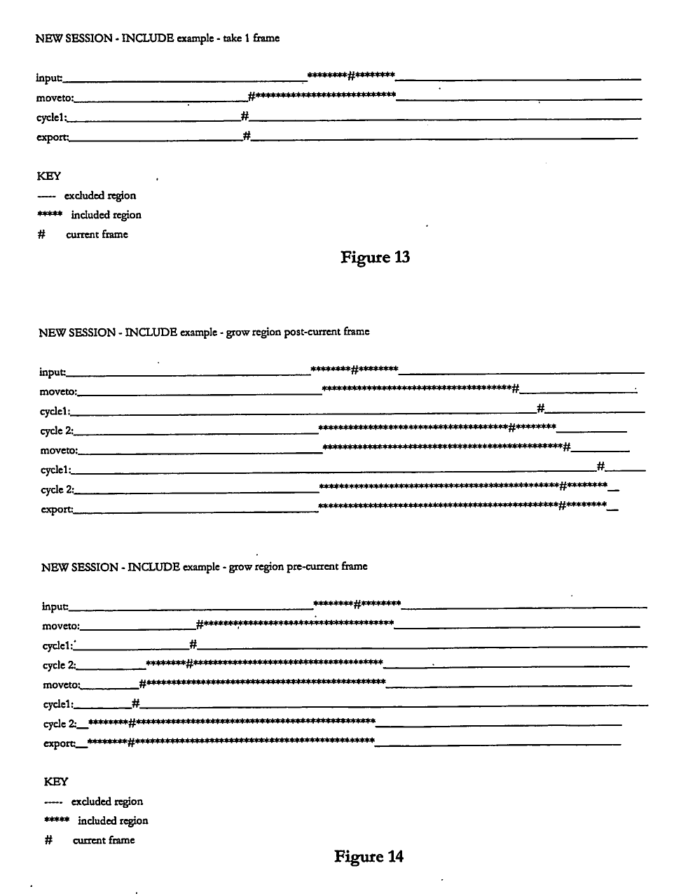

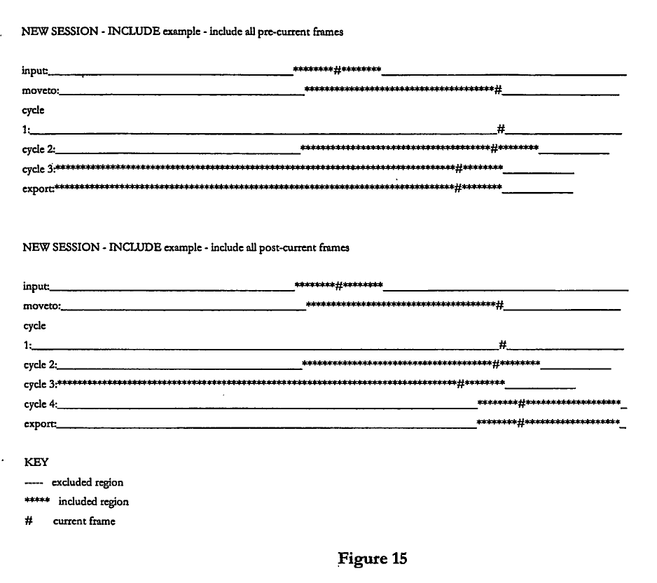

Means are provided for the user to manipulate the region of the video message that is included. The user operates the ‘forward’ and ‘backward’ shuttle buttons, ‘include’ button, and ‘apply’ button in order to grow regions of the video clip for inclusion in the final edit. Assuming that the user has stopped at a frame in a region of interest the interaction is as follows:
Referring to FIG. 11: If the ‘apply’ button is pressed the predicted region is exported as a new clip, without further interactions.
Referring to FIG. 12: If the ‘forward’ or ‘backward’ shuttle buttons are pressed and released at a given frame, followed by the ‘apply’ button, the included region is extended up to that frame.
Referring to FIG. 13: If the ‘include’ button is pressed once the part of the edit bar under the frame pointer goes green to indicate that only the current frame is included; the rest of the bar remains unchanged.
Referring to FIG. 14: If the ‘include’ button is pressed once more, a region corresponding to the support before and after the frame pointer position goes green to indicate that this region is included in addition to the currently included frames; the rest of the bar remains unchanged.
Referring to FIG. 15: If the ‘include’ button is pressed once more, a region from the start of the bar up to the pointer and a region corresponding to the support after the frame pointer position goes green to indicate that all the frames from the beginning of the video to the current position are included, and a number of frames after the current position corresponding to the support are also included.
Referring to FIG. 15 again: If the ‘include’ button is pressed once more, a region from the end of the bar back to the pointer and a region corresponding to the support before the frame pointer position goes green to indicate that all the frames from the current position to the end of the video are included, and a number of frames before the current position corresponding to the support are also included.
Further presses repeatedly cycle round the four above cases.

The user can also operate two ‘handles’ on the edit bar that define the start and end of the included region, respectively.

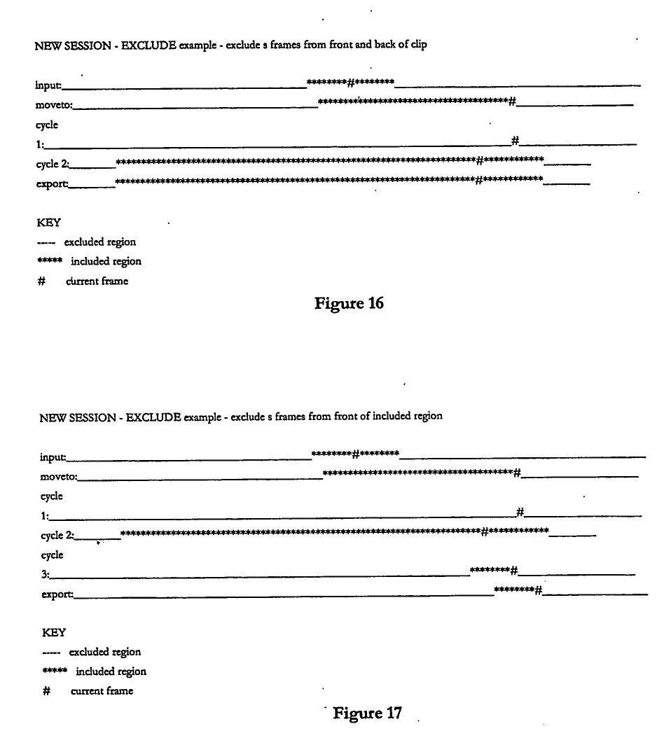

The user can also operate the ‘exclude’ button to grow regions of the video clip for exclusion from the final edit. Assuming that the user has stopped at a frame in a region of interest the interaction is as follows:
If the ‘exclude’ button is pressed once then all of the edit bar apart from that under the frame pointer goes red to indicate that only the current frame is ‘included’; the rest of the bar remains unchanged. This is equivalent to the first ‘include’ cycle.
Referring to FIG. 16: If the ‘exclude’ button is pressed once more, a region corresponding to the support at the start and end of the clip goes red to indicate that these regions are ‘excluded’; the rest of the bar remains unchanged.
Referring to FIG. 17: If the ‘exclude’ button is pressed once more, a region of size s at the start of the currently included region goes red to indicate that these frames are ‘excluded’.
If the ‘exclude’ button is pressed once more, a region of size s at the end of the currently included region goes red to indicate that these frames are ‘exduded’.

Further presses repeatedly cycle round the four above cases.

Means are provided for the user to export the edited video message. The user operates the ‘apply’ button to export the edited video message.

Means are also provided for the user to select further options prior to completion:

The user can select, through interaction with a menu, the following:
add ‘fades’ where frames have been deleted.
add ‘transitions’ where frames have been deleted.
add a background music track
add text annotation.

If any editing operation results in a single stationary frame being displayed to the user then this frame can be treated as a still image and processed separately.

The system monitors the support for the currently displayed frame and, if this is equal to one, asks the user via a message box whether this frame is required as a still image; if the user replies ‘yes’ then the still is captured and stored, and the editing session can then proceed.

As a simple example of the use of the invention consider this scenario. Using a built-in camera, a user of a mobile phone captures a short segment of video from a birthday party and wishes to trim the segment This trimming operation is wanted in order, both to focus in on the moment when the children blow out the candles on the birthday cake, and to minimise the cost of mailing the video segment to friends and family. The video segment is shuttled until the actual frame when the candles go out is displayed. The “include’ button is pressed twice and the preparation tool, based on the past history of user interaction, determines that three seconds of video before and after the chosen frame should be included in the edit. The user runs to the start of the ‘included’ region and, using the ‘include’ button, adds more frames to the final edit. The user then quickly runs forward and backward checking that green ‘tick’ markers appear in the part of the clip of interest; then the ‘apply’ button is pressed and the editing process is completed. The system measures the actual number of frames set as ‘included’ and updates the memory variables used for future prediction.

Extensions

The system described above is capable of predicting the frames that are to be subject to a subsequent selection action based on empirical information defining past user behaviour. It is also possible for predictions to be based on pattern classification applied to the frame content using fuzzy logic or neural nets or by applying pre-defined rules to meta-data stored with the frames or other kinds of data that can be extracted from the frames by suitable processing.

1. A computer based system for selecting digital media frames, the system being capable of predicting the frames that are to be subject to a subsequent selection action.

2. The system of claim 1 in which the subsequent selection action is the selection of the predicted frames for inclusion to create a new clip.

3. The system of claim 2 in which the subsequent selection action is the selection of the predicted frames for exclusion from a new clip.

4. The system of claim 3 in which the device holds in device memory information that defines how a user has previously selected frames for inclusion or exclusion; the device using that information to predict how the user wishes to select frames for inclusion or exclusion in the future in a way that is consistent with previous behaviour.

5. The system of claim 4 in which the information held in device memory that is used for frame prediction is updated whenever the user completes the subsequent selection action.

6. The system of claim 4 in which the information determines the number of frames that the system predicts wilt be subject to selection.

7. The system of claim 1 that graphically represents frames and combines those graphically represented frames with a graphical indication of the prediction of which of those graphically represented frames are to be subject to the subsequent selection action.

8. The system of claim 1 in which the system predicts the frames that are to be subject to the subsequent action after the user has selected an initial frame.

9. The system of claim 8 in which the initial frame is intended to be one of the following options: the sole frame to be used; the middle of a clip; the start of a clip; the end of a clip.

10. The system of claim 9 in which the user can task or navigate through the options by repetitively selecting a button or menu option.

11. The system of claim 1 in which the system enables the user to select further actions to be performed on frames; the further actions being selected from the list: annotations; effects; transitions.

12. The system of claim 1 where the frames are video and/or audio frames.

13. The system of claim 1 that is integrated with a media player application such that system controls are displayed at the same time as controls for the media player application are displayed.

14. The system of claim 1 wherein the device is selected from the following list: laptop computer, mobile PDA with wireless connectivity, mobile telephone, set-top box; hard-disc based personal video recorders (PVR).

15. The system of claim 1 in which the frames, or a list of those frames, that have been subject to the subsequent selection action are exported.

16. The system of claim 1 which is capable of predicting the frames that are to be subject to a subsequent selection action based on pattern classification applied to the frame content using fuzzy logic or neural nets or by applying pre-defined rules to meta-data stored with the frames or other kinds of data that can be extracted from the frames by suitable processing.

17. A method of selecting digital media frames, comprising the step of predicting the frames that are to be subject to a subsequent selection action.
